(19) United States
(12) Patent Application Publication
(10) Pub. No.: US 2010/0078125 A1
(43) Pub. Date: Apr. 1, 2010

(54) Method for securing a curved circuit board in die bonder and recording medium containing program for securing a curved circuit board in die bonder

(75) Inventors: Noboru Fujino, Musashimurayama-shi (JP); Kazuhiro Fujisawa, Musashimurayama-shi (JP); Yoshifumi Katayama, Musashimurayama-shi (JP); Yutaka Odaka, Musashimurayama-shi (JP)

Correspondence Address: QUINN EMANUEL;KODA & ANDROLIA, 865 S. FIGUEROA STREET, 10TH FLOOR, LOS ANGELES, CA, 90017, US

(73) Assignee: Kabushiki Kaisha Shinkawa

(21) Appl. No.: 12/286,580

(22) Filed: Oct. 1, 2008

(51) Int. Cl. B29C 65/00

(52) U.S. Cl. 156/285

(57) ABSTRACT

A method and a program (recorded on a recording medium) for securing a curved circuit board in a flat fashion on (a film application stage and) a bonding stage of a die bonder provided with suction cavities formed in a substrate suction surface of the bonding stage that suctions the curved circuit board, including the steps of evacuating air from the vacuum suction cavities using a vacuum device, and moving a die collet provided at a tip end of a bonding arm to press the circuit board down and thus sealing at least one of the vacuum suction cavities by the circuit board so as to allow the remaining vacuum suction cavities to be sealed successively by the flattened circuit board, thereby sealing the upper surfaces of all the vacuum suction cavities by the flattened circuit board, so that the circuit board is suction-held and secured on the bonding stage.

### BACKGROUND OF THE INVENTION

The present invention relates to methods for suctioning a curved circuit board in place on a bonding stage or a film application stage of a die bonder and to a recording medium containing programs executing such methods.

A typical die bonder that bonds a semiconductor die to a circuit board bonds a semiconductor die while suctioning and securing a circuit board being transferred to the upper face of a bonding stage by vacuum. In contrast, with recent demands for thinner semiconductor packages with improved functionalities and manufacturing efficiency, circuit boards are increasingly thinned and large-sized and multi-layer mounting of dies or so-called stacking is more and more commonly employed (for example, see Japanese Unexamined Patent Application Publication No. 2004-6599). However, a thinned circuit board often involves a curvature or warpage, resulting in that the die bonding cannot be performed because it is not possible to suction and fix such a curved or warped circuit board to a bonding stage by vacuum. Moreover, in the case of the multi-layer mounting that has become commonly employed, bonding of a semiconductor die results in a warpage in a circuit board, and the warpage in the circuit board becomes greater as the number of layers increases. This disadvantageously makes it difficult to suction the circuit board to a bonding stage, often hindering the die bonding.

Further, in a method of bonding a semiconductor die to a circuit board that has been employed in recent years, a film for thermocompression bonding is first applied to the circuit board and then the semiconductor die is heated and bonded to the circuit board with the film interposed therebetween (for example, see Japanese Unexamined Patent Application Publication No. 2004-6599). In the multi-layer mounting of semiconductor dies according to this method, another thermocompression film is applied to the semiconductor die that has been mounted, and another semiconductor die is heated and bonded to the circuit board with the film interposed therebetween. In order to bond a semiconductor die in close contact with a circuit board or a previously mounted semiconductor die, it is required to evenly apply a thin thermocompression film over the circuit board or the previously mounted semiconductor die. For this purpose, the thermocompression film is applied to the circuit board being fixed to a film application stage by vacuum suctioning in the same manner in which the circuit board is fixed to a bonding stage for carrying out the die bonding. In the multi-layer mounting of semiconductor dies, the degree of curvature occurring in the circuit board becomes greater as the number of layers increases, and consequently, this often causes failure in suctioning of the circuit board to the film application stage, thus hindering the die bonding.

As a conventional method that ensures suctioning and securing, to such a bonding stage in this manner, of a curved circuit board or a circuit board that has become curved after mounting of a semiconductor die thereon, there is a suction fixation apparatus that moves a suction tube having a vacuum suction hole therein and penetrating through the bonding stage upward and downward. When the curved circuit board mounted with a semiconductor die is transferred to the bonding stage, the suction tube moves upward so as to come into contact with the circuit board and suctions the circuit board with the vacuum suction hole therethrough. Then, the suction tube moves downward, suctions and fixes the circuit board with the vacuum suction hole of a substrate suction surface (for example, see Japanese Unexamined Patent Application Publication No. 2000-138253). In another known method, a bellow-type vacuum gripper provided for a penetrating hole in the bonding stage is allowed to move upward and downward through the penetrating hole, thereby the circuit board is drawn to the substrate suction surface (for example, see Japanese Unexamined Patent Application Publication No. 2001-203222).

When bonding a semiconductor die to a circuit board or stacking another semiconductor die(s) to a semiconductor die that has been bonded to a circuit board, there is a case in which either the circuit board or the semiconductor die on the circuit board is required to be heated. However, a conventional arrangement for suctioning a circuit board as shown in Japanese Unexamined Patent Application Publications No. 2000-138253 and No. 2001-203222 is provided with a device, under a bonding stage, that moves a suction tube and/or a vacuum gripper upwardly and downwardly. Such an arrangement, however, cannot be provided with a heating device under the bonding stage and consequently cannot be applyed as a bonder that carries out bonding and heating at the same time.

For this reason, a method with which a circuit board is pressed down onto a bonding stage from the top of the circuit board instead of drawing the circuit board from beneath the bonding stage is proposed. In one example of such a method, as shown in FIG. 20, a circuit board 35 that has been transferred to a bonding stage 24 along a frame feeder 17 is pressed down against a substrate suction surface 24a of the bonding stage 24 by being blown by air from an air nozzle 71 provided above the upper surface of the circuit board 35, thereby being suctioned and secured through vacuum suction holes 27 provided in the bonding stage 24 (for example, see Japanese Unexamined Patent Application Publication No. 2000-138253). In an alternative example, as shown in FIGS. 21(a), 21(b) and 21(c), both ends of the circuit board 35 mounted with a semiconductor die 25 is gripped by gripper elements 73a and 73b of grippers 73, respectively, so that the circuit board 35 is pulled to both sides to be flattened, and then the grippers 73 are moved down to press the circuit board 35 against the bonding stage 24. Then, the circuit board 35 is pressed against the substrate suction surface 24a of the bonding stage 24 so as to be suctioned and secured through the vacuum suction holes 27 (for example, see Japanese Unexamined Patent Application Publication No. 2001-176915).

However, in the conventional art shown in FIG. 20, there is a problem that a wire 34 that has been bonded to the semiconductor die 25 and the circuit board 35 is bent by a wind pressure when the air is blown from above and as a result the wire 34 is brought into contact with another wire 34. Further, in the conventional art shown in FIGS. 21(a), 21(b) and 21(c), while a device that drives the gripper is not required to be provided under the bonding stage 24, there is a problem that the apparatus often becomes large and complex because a large driving arrangement is required to be provided next to the bonding stage 24.

### BRIEF SUMMARY OF THE INVENTION

In view of the above noted problems, an object of the present invention is to provide a simple method capable of suctioning a curved circuit board in place on a bonding stage or a film application stage of a die bonder in an efficient manner.

A method for securing a curved circuit board in a die bonder according to the present invention is a method for securing a curved circuit board in a die bonder, the method comprising the step of
providing a bonding stage having at least one vacuum suction cavity on a substrate suction surface thereof for suctioning a circuit board;
providing a die collet for attaching a semiconductor die to a bonding target; and
pressing down a curved circuit board to the bonding stage using the die collet so that the circuit board seals the at least one vacuum suction cavity.

A method for securing a curved circuit board in a die bonder according to the present invention is a method for securing a curve circuit board in a die bonder for bonding a semiconductor die to a bonding target with a bonding film interposed therebetween, the method comprising the steps of:
providing a bonding stage having at least one vacuum suction cavity on a substrate suction surface thereof for suctioning a circuit board;
providing a die collet for attaching a semiconductor die to a bonding target;
providing a film application stage having at least one vacuum suction cavity on a substrate suction surface thereof for suctioning a circuit board;
providing a film application collet for applying a bonding film to the bonding target; and
pressing down a curved circuit board to the film application stage using the film application collet so that the circuit board seals the at least one vacuum suction cavity.

The method for securing a curved circuit board in a die bonder according to the present invention can be such that a surface of a tip end of the film application collet is smaller than a central area which is within an electrode pad region provided along a periphery of the semiconductor die, and when bonding more than one semiconductor die to the circuit board in a multi-stacking manner, the curved circuit board is pressed down to the film application stage using the film application collet by pressing down the central area of the semiconductor die that is disposed either as a single stack semiconductor die or on top of multi-stacked semiconductor dies. The method for securing a curved circuit board in a die bonder according to the present invention can also be such that when bonding more than one semiconductor die to the circuit board in a multi-stacking manner, the curved circuit board is pressed down to the bonding stage using the die collet by pressing down the semiconductor die to which the bonding film is applied and that is disposed either as a single stack semiconductor die or on top of multi-stacked semiconductor dies. The method for securing a curved circuit board in a die bonder according to the present invention can also be such that the surface of a tip end of the die collet is smaller than a central area which is within an electrode pad region provided along a periphery of the semiconductor die, and the curved circuit board is pressed down to the bonding stage by pressing the central area of the semiconductor die to which the bonding film is applied. It is also preferable that the method for securing a curved circuit board in a die bonder according to the present invention further includes the steps, after pressing down the curved circuit board to one of the bonding stage and the film application stage, of: a vacuum suction state confirming step of confirming whether or not the circuit board has been suctioned by vacuum to the one of the bonding stage and the film application stage; and a press-down repeating step of, when the vacuum suctioning of the circuit board has not been confirmed in the vacuum suction state confirming step, changing a position in X and Y directions at which the curved circuit board is pressed down, moving one of the die collet and the film application collet that corresponds to the one of the bonding stage and the film application stage to a position after the change, and again pressing the curved circuit board to the one of the bonding stage or the film application stage.

A method for securing a curved circuit board in a die bonder according to the present invention is a method for securing a curved circuit board in a die bonder which is for bonding a semiconductor die to a bonding target with a bonding film interposed therebetween, the method comprising the steps of:
providing a bonding stage having at least one vacuum suction cavity on a substrate suction surface thereof for suctioning a circuit board;
providing a die collet for attaching a semiconductor die to a bonding target;
providing a film application stage having at least one vacuum suction cavity on a substrate suction surface thereof for suctioning a circuit board;
providing a film application collet for applying a bonding film to the circuit board;
a circuit board setting step of confirming a position of a curved circuit board that is transferred onto one of the bonding stage and the film application stage and then activating a vacuum apparatus connected to each of the bonding stage and the film application stage;
a pressing position setting step of, after the circuit board setting step, setting a position in X and Y directions at which the curved circuit board is pressed down;
a collet moving step of moving one of the die collet and the film application collet to the position in X and Y directions that has been set in the pressing position setting step, the one of the die collet and the film application collet being corresponding to the one of the bonding stage and the film application stage;
a pressing step of pressing down the curved circuit board to the one of the bonding stage and the film application stage by the one of the die collet and the film application collet so that the circuit board seals the at least one vacuum suction cavity;
a vacuum suction state confirming step of, after the pressing step, confirming whether or not the circuit board has been suctioned by vacuum to the one of the bonding stage and the film application stage; and
a press-down repeating step of, when the vacuum suctioning of the circuit board has not been confirmed in the vacuum suction state confirming step, changing the position in X and Y directions at which the curved circuit board is pressed down, moving the one of the die collet and the film application collet to a position after the change, and again pressing the curved circuit board to the one of the bonding stage and the film application stage.

A recording medium recorded with a program for securing a curved circuit board in a die bonder is a recording medium recorded with a program for securing a curved circuit board in a die bonder which is for bonding a semiconductor die to a bonding target with a bonding film interposed therebetween, the die bonder including
a bonding stage having at least one vacuum suction cavity on a substrate suction surface thereof for suctioning a circuit board,
a die collet that attaches a semiconductor die to a bonding target,
a film application stage having at least one vacuum suction cavity on a substrate suction surface thereof for suctioning a circuit board,
a film application collet that applies a bonding film to the bonding target, and
a computer having a control unit, and

it is characterized in that the program on the recording medium is executed by the control unit and performs the processes of:
a circuit board setting process for confirming a position of a curved circuit board that is transferred onto one of the bonding stage and the film application stage and then activating a vacuum apparatus connected to each of the bonding stage and the film application stage;
a pressing position setting process, after the circuit board setting process, for setting a position in X and Y directions at which the curved circuit board is pressed down;
a collet moving process for moving one of the die collet and the film application collet to the position in X and Y directions that has been set in the pressing position setting process, the one of the die collet and the film application collet being corresponding to the one of the bonding stage and the film application stage;
a pressing process for pressing down the curved circuit board to the one of the bonding stage and the film application stage by the one of the die collet and the film application collet so that the circuit board seals the at least one vacuum suction cavity;
a vacuum suction state confirming process, after the pressing process, for confirming whether or not the circuit board has been suctioned by vacuum to the one of the bonding stage and the film application stage; and
a press-down repeating process for, when the vacuum suctioning of the circuit board has not been confirmed in the vacuum suction state confirming process, changing the position in X and Y directions at which the curved circuit board is pressed down, moving the one of the die collet and the film application collet to a position after the change, and again pressing the curved circuit board to the one of the bonding stage and the film application stage.

The present invention provides such an advantageous effect that a curved circuit board can be efficiently secured to a bonding stage or a film application stage of a die bonder using a simple method.

### BRIEF DESCRIPTION OF THE DRAWINGS

FIG. 1 is a top plan view illustrating a structure of a die bonder according to an exemplary embodiment of the present invention;

FIG. 2 is an elevational view illustrating the structure of the die bonder according to an exemplary embodiment of the present invention;

FIG. 3 is a diagram illustrating a system structure of the die bonder that carries out a method and executes a program for securing a curved circuit board according to an exemplary embodiment of the present invention;

FIG. 4 is a top plan view illustrating an upper surface of a film application stage and a bonding stage of the die bonder shown in FIG. 1;

FIG. 5 is a cross-sectional view of the film application stage and the bonding stage of the die bonder shown in FIG. 1;

FIGS. 6(a) and 6(b) are explanatory diagrams illustrating a structure of a die collet of the die bonder shown in FIG. 1;

FIGS. 7(a) and 7(b) are explanatory diagrams illustrating a structure of a film application collet of the die bonder shown in FIG. 1;

FIG. 8 is a flowchart of a program for securing a curved circuit board to the film application stage according to the exemplary embodiment of the present invention;

FIG. 9 is a flowchart of a program for securing a curved circuit board to the bonding stage according to the exemplary embodiment of the present invention;

FIG. 10 is an explanatory diagram illustrating the curved circuit board placed on the film application stage according to the exemplary embodiment of the present invention;

FIG. 11 is an explanatory diagram illustrating the film application collet being moved to a position at which the curved circuit board is pressed down according to the exemplary embodiment of the present invention;

FIG. 12 is an explanatory diagram illustrating the film application collet starting to press the curved circuit board down according to the exemplary embodiment of the present invention;

FIG. 13 is an explanatory diagram illustrating the curved circuit board when the film application collet has reached at a position at which the collet stops moving down according to the exemplary embodiment of the present invention;

FIG. 14 is an explanatory diagram illustrating the curved circuit board being suctioned and secured to the film application stage according to the exemplary embodiment of the present invention;

FIG. 15 is an explanatory diagram illustrating a film for thermocompression bonding of a semiconductor die, the film being applied to a semiconductor die bonded to the circuit board that is being suctioned and secured to the film application stage according to the exemplary embodiment of the present invention;

FIG. 16 is an explanatory diagram illustrating the die collet starting to press the curved circuit board down according to the exemplary embodiment of the present invention;

FIG. 17 is an explanatory diagram illustrating the curved circuit board suctioned and secured to the bonding stage according to the exemplary embodiment of the present invention;

FIG. 18 is an explanatory diagram illustrating a second-stage semiconductor die bonded onto the thermocompression film, the film being applied to the semiconductor die bonded to the circuit board that is suctioned and secured to the bonding stage according to the exemplary embodiment of the present invention;

FIG. 19 is an explanatory diagram illustrating the circuit board suctioned and secured when stacking semiconductor dies on the circuit board with a film spacer therebetween according to the exemplary embodiment of the present invention;

FIG. 20 is a diagram illustrating a method for securing a circuit board according to the conventional art; and

FIGS. 21(a), 21(b) and 21(c) are diagrams illustrating another method for securing a circuit board according to the conventional art.

### DETAILED DESCRIPTION OF THE INVENTION

In the following, an exemplary embodiment of a method for securing a curved circuit board according to the present invention will be described. Prior to an explanation of the exemplary embodiment of the method for securing a curved circuit board, a structure of a die bonder in which the method of the present invention is used will be described with reference to the accompanying drawings.

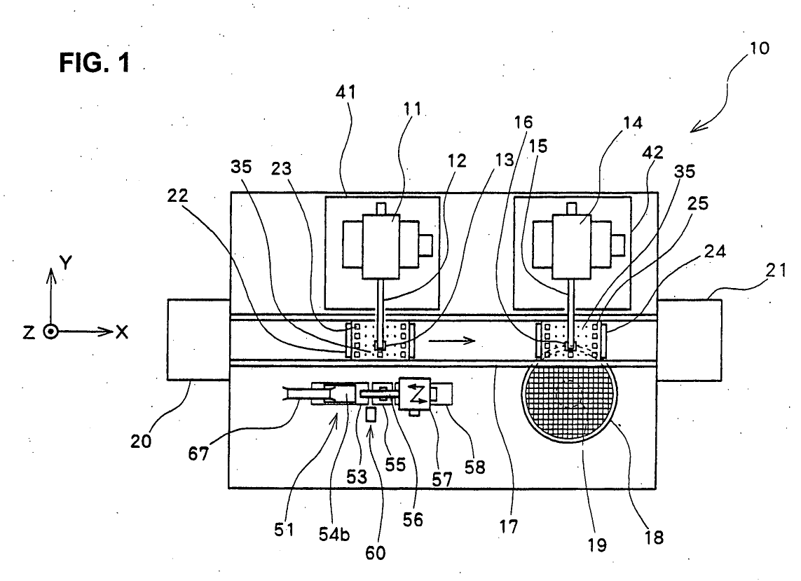

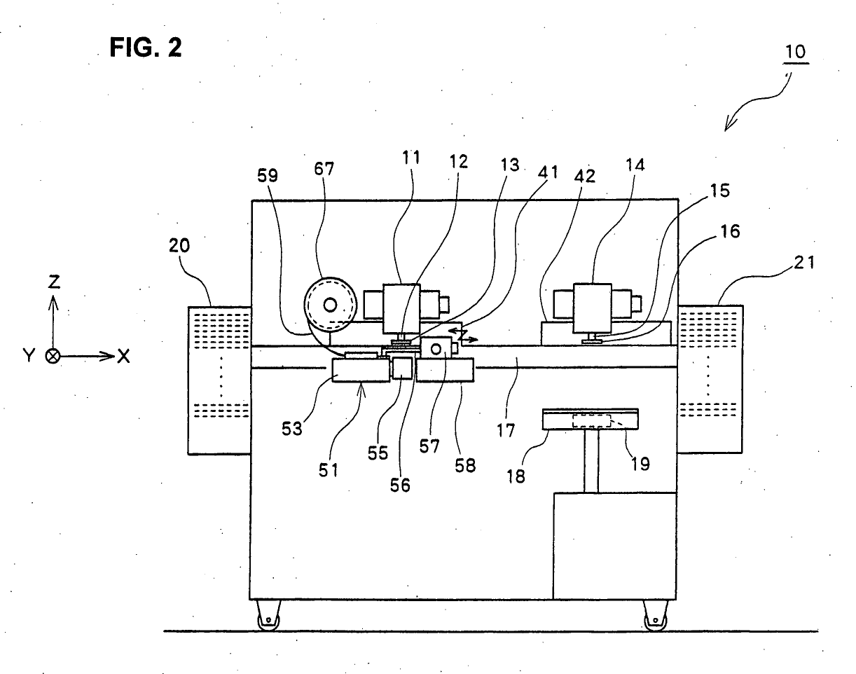

As shown in FIG. 1 and FIG. 2, a die bonder 10 is provided with a film application stage 22 to which a circuit board 35 is suctioned and secured for applying a film for thermocompression bonding of a semiconductor die, a film application head 11 that applies a thermocompression film 23, which is congigured to bond a semiconductor die and called bonding film, onto the circuit board 35 or onto a semiconductor die 25 that has been bonded to the circuit board 35, an X-Y table 41 that drives the film application head 11 in X and Y directions, a bonding stage 24 that suctions and secures the circuit board 35 to mount the semiconductor die 25 thereon, a bonding head 14 that bonds the semiconductor die 25 with heat onto the thermocompression film 23, an X-Y table 42 that drives the bonding head 14 in the X and Y directions, a frame feeder 17 that feeds the circuit board 35 to the film application stage 22 and to the bonding stage 24, a cutter 60 that cuts a roll of thermocompression film 59 to obtain each thermocompression film 23, a film carrying device 51 that carries the thermocompression film roll 59 to the cutter 60, and a wafer holder 18 that holds a wafer that has been diced. In the following description, a direction X represents the direction along which the circuit board 35 is fed, a direction Y represents the direction that is perpendicular to the X direction in the horizontal plane, and a direction Z represents the direction that is vertical to the X direction.

The film application head 11 is movable within the XY plane and is provided with a film application arm 12 having a film application collet 13 at a tip end of the arm 12. Further, the film application head 11 is internally provided with a Z motor that moves the tip end of the film application arm 12 in the Z direction. The film application collet 13 which is at the tip end of the film application arm 12 is movable in the X and Y directions according to the movement of the film application head 11 in the X and Y directions as well as in the Z direction by the Z motor.

The bonding head 14, similarly to the film application head 11, is also movable within the XY plane and is provided with a bonding arm 15 having a die collet 16 at a tip end of the arm 15. The bonding head 14 is internally provided with a Z motor that moves the tip end of the bonding arm 15 in the Z direction. The die collet 16 at the tip end of the bonding arm 15 is movable in the X and Y directions according to the movement of the bonding head 14 in the X and Y directions as well as in the Z direction by the Z motor.

The frame feeder 17 is provided with a pair of facing groove-shaped guide rails extending along the X direction of the die bonder 10 and a lead frame carrying device that is not shown in the drawing. The frame feeder 17 is further provided with a frame loader 20 that feeds the circuit board 35 to the frame feeder 17 at one end thereof and a frame unloader 21 that removes the circuit board 35, which has gone through die bonding process, from the frame feeder 17 at the other end.

As shown in FIG. 1 and FIG. 2, the film carrying device 51 and the cutter 60 are provided at a position roughly corresponding to the film application head 11 on an opposing side of the die bonder 10 in the Y direction across the frame feeder 17. The film carrying device 51 is provided with a guide 53 that guides the thermocompression film roll 59, a drawing arm 56 that suctions and draws the roll 59, and a holding plate 55 that suctions and holds the roll 59. Moreover, as shown in FIG. 1 and FIG. 2, the cutter 60 is provided on a side of the guide 53 and the holding plate 55 facing away from the film application head 11, and it is configured to cut the thermocompression film roll 59 between the guide 53 and the holding plate 55 to obtain the thermocompression film 23.

As shown in FIG. 1 and FIG. 2, the wafer holder 18 is provided at a position roughly corresponding to the bonding head 14 on the opposing side of the die bonder 10 in the Y direction across the frame feeder 17. The wafer holder 18 is provided with a die lifting unit 19. The die lifting unit 19 lifts one of the semiconductor dies 25 arranged on a wafer that is held by the wafer holder 18 and positions the one semiconductor die 25 at a poison higher than the rest of the semiconductor dies 25, so the die collet 16 suction-holds the lifted semiconductor die 25.

An operation of the bonding by the die bonder 10 configured in this manner will be briefly described. The thermocompression film roll 59 that is pulled onto the holding plate 55 from the guide 53 by the film carrying device 51 is cut by the cutter 60, thereby the thermocompression film 23 is obtained on the holding plate 55. At the same time, the circuit board 35 that is fed from the frame loader 20 is transferred in the X direction by the frame feeder 17 to a position of the film application stage 22. The transferred circuit board 35 is suctioned and secured to the film application stage 22. Once the circuit board 35 is suctioned and secured, the film application head 11 moves the film application collet 13 in the X, Y, and Z directions, picks up the thermocompression film 23 from the holding plate 55, and applies the film 23 to a predetermined position on the circuit board 35. Upon completion of the application of the thermocompression film 23 to all of the positions, the circuit board 35 is released from the film application stage 22, and transferred in the X direction by the frame feeder 17 to the bonding stage 24. Then, the transferred circuit board 35 is suctioned and secured to the bonding stage 24. Once the circuit board 35 is suctioned and secured, the bonding head 14 moves the die collet 16 in the X, Y, and Z directions, picks up one of the semiconductor dies 25 that is lifted by the die lifting unit 19 from a wafer on the wafer holder 18, and bonds the die 25 that has been picked up to the thermocompression film 23 on the circuit board 35. At this time, the circuit board 35 has been heated, and consequently, the bonding resin in the thermocompression film 23 is melted and the semiconductor die 25 is firmly bonded to the circuit board 35. This operation is repeated until all of the semiconductor dies 25 to be mounted are bonded to the circuit board 35, and then the circuit board 35 with the semiconductor dies 25 being bonded is transferred by the frame feeder 17 to the frame unloader 21 and removed for the next step of the semiconductor process.

Now, a method and program for securing a curved circuit board in the die bonder 10 as described above will be described below. In the following description, the X, Y, and Z directions shown in the drawings represent the same directions as described referring to FIG. 1 and FIG. 2. Further, the like components as described in FIG. 1 and FIG. 2 are represented by the like reference numerals and descriptions for these components are omitted.

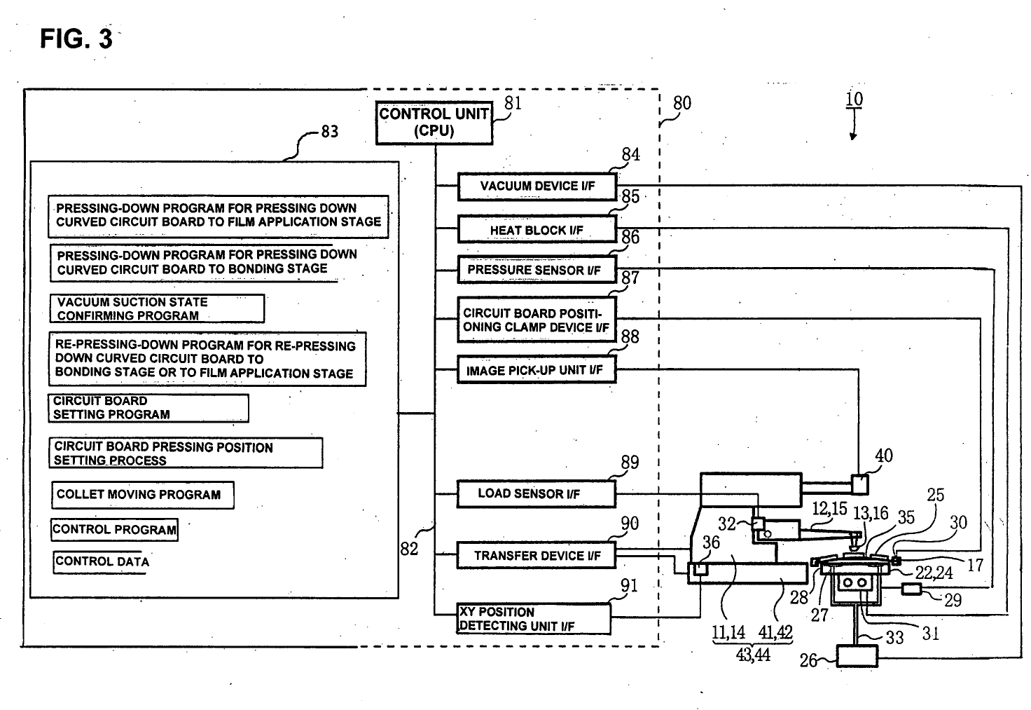

As shown in FIG. 3, the die bonder 10 according to this exemplary embodiment is provided with the film application head 11 and the bonding head 14 that are respectively disposed above the X-Y tables 41 and 42. The film application head 11 and the bonding head 14 are provided with the film application arm 12 and the bonding arm 15, respectively. At the tip end of the film application arm 12, the film application collet 13 that applies the thermocompression film 23, which is configured to bond a semiconductor die, to a bonding target, which is either the circuit board 35 or the semiconductor die 25 that has been bonded to the circuit board 35, is disposed. At the tip end of the bonding arm 15, the die collet 16 that bonds the semiconductor die 25 to the bonding target, which is either the circuit board 35 or the semiconductor die 25 that has been bonded to the circuit board 35, is disposed. The X-Y table 41 and the head 11, and the X-Y table 42 and the head 14 respectively form transfer devices 43 and 44. The transfer devices 43 and 44 are respectively able to move the heads 11 and 14 to any given positions within a horizontal plane (X-Y plane) using the corresponding X-Y tables 41 and 42. The transfer devices 43 and 44 are also respectively able to freely move the collets 13 and 16 attached to the tip ends of the film application arm 12 and the bonding arm 15 in the X, Y, and Z directions by driving the corresponding film application arm 12 and the bonding arm 15 attached to the transfer devices 43 and 44 in the Z direction. Each one of the X-Y tables 41 and 42 is provided with an XY position detecting unit 36 that detects a position in the X and Y directions of the tip end of the corresponding each one of the collets 13 and 16. The XY position detecting unit 36 detects XY coordinates of a position of a predetermined portion of the film application head 11 or the bonding head 14 and corrects a distance between the predetermined portion and the tip end of the collet 13 or 16 in the X and Y directions, thereby determining a position in the X and Y directions of the tip end of the collet 13 or 16. The XY position detecting unit 36 can be of a noncontact type, such as electrical or optical, or of a contact type, such as mechanical. Further, the XY position detecting unit 36 can be a position sensor that directly determines the position of the tip end of the collet 13 or 16 without correcting the measured value of the position of the predetermined portion of the film application head 11 or the bonding head 14, as long as the position in the X and Y directions of the tip end of the collet 13 or 16 can be measured. Moreover, the XY position detecting unit 36 can be a linear scale. Each one of the film application head 11 and the bonding head 14 is provided with a load sensor 32 that detects a load applied on the tip end of the corresponding collet 13 or 16. Further, each one of the film application head 11 and the bonding head 14 is provided with an image pick-up unit 40 that picks an image of the corresponding collet 13 or 16, the semiconductor die 25, the thermocompression film 23 for bonding a semiconductor die, and the circuit board 35.

The film application stage 22 and the bonding stage 24 to which the circuit board 35 is suctioned and secured are provided on a-frame, which is not shown in the drawings, of a die bonder. The frame feeder 17 that guides the circuit board 35 is fixed on both sides of the film application stage 22 and the bonding stage 24, and a circuit board positioning clamp device 30 that clamps the circuit board 35 and moves the circuit board 35 to a predetermined position is provided in the vicinity of the frame feeder 17. The film application stage 22 and the bonding stage 24 are each provided with a plurality of vacuum suction cavities 28 which are evacuated when the upper faces of the cavities 28 are sealed by the circuit board 35, and a vacuum suction hole 27 is opened at the bottom of each of the vacuum suction cavities 28. The vacuum suction hole 27 is connected to a vacuum device 26 via a vacuum pipe 33. Pressure sensors 29 that detect the pressure in the vacuum suction cavities 28 are respectively provided in the vicinity of the film application stage 22 and the bonding stage 24. Each pressure sensor 29 can consecutively output a signal of a measured pressure, or can be a pressure switch that outputs a signal when the pressure reaches a predetermined level. More than one pressure sensor 29 can be provided for each of the film application stage 22 and the bonding stage 24 so that each pressure sensor 29 detects the pressure in each vacuum suction cavity 28. The pressure sensor 29 can also be provided at the vacuum suction hole 27 under the vacuum suction cavity 28. Alternatively, the pressure sensor 29 can be provided at one or more portions of the vacuum pipe 33 that connects the vacuum device 26 and the vacuum suction hole 27. In addition, a heat block 31 that heats the circuit board 35 mounted with the semiconductor die 25 that is suctioned by vacuum is provided under each of the film application stage 22 and the bonding stage 24.

The transfer devices 43 and 44 are connected to a transfer device interface (I/F) 90, the XY position detecting units 36 respectively provided on the heads 11 and 14 are connected to an XY position detecting unit interface (I/F) 91, and the load sensors 32 respectively provided for the heads 11 and 14 are connected to a load sensor interface (I/F) 89. In addition, each one of the heads 11 and 14 is provided with an image pick-up unit 40 having a digital image sensor, and the image pick-up units 40 are connected to an image pick-up unit interface (I/F) 88. The circuit board positioning clamp devices 30 are connected to a circuit board positioning clamp device interface (I/F) 87, and the pressure sensors 29 respectively provided for the stages 22 and 24 are connected to a pressure sensor interface (I/F) 86, the vacuum devices 26 are connected to a vacuum device interface (I/F) 84, and the heat blocks 31 respectively provided for the stages 22 and 24 are connected to a heat block interface (I/F) 85. Further, each one of the above-described interfaces is connected through a data bus 82 to a control unit 81 that controls actions of the die bonder 10. The control unit 81 includes a CPU which is for controlling the bonding action, and to the data bus 82 is connected a memory unit 83 that stores control data and programs that are recorded on a recording medium and execute securing of a circuit board, including, as shown in FIGS. 3, 8 and 9, a pressing-down program for pressing down curved circuit board to film application stage, a pressing-down program for pressing down curved circuit board to bonding stage, a vacuum suction state confirming program, a re-pressing-down program for re-pressing down curved circuit board to bonding stage or to film application stage, a circuit board setting program, a circuit board pressing position setting process, and a collet moving program. The control unit 81, each of the interfaces 84 to 91, the memory unit 83, and the data bus 82 form a computer 80. The interfaces 84 to 91 can be provided for each of the heads 11 and 14, or can be shared by the heads 11 and 14. Moreover, the control unit 81 can be shared by both of the heads 11 and 14, or can be provided for each of the heads 11 and 14.

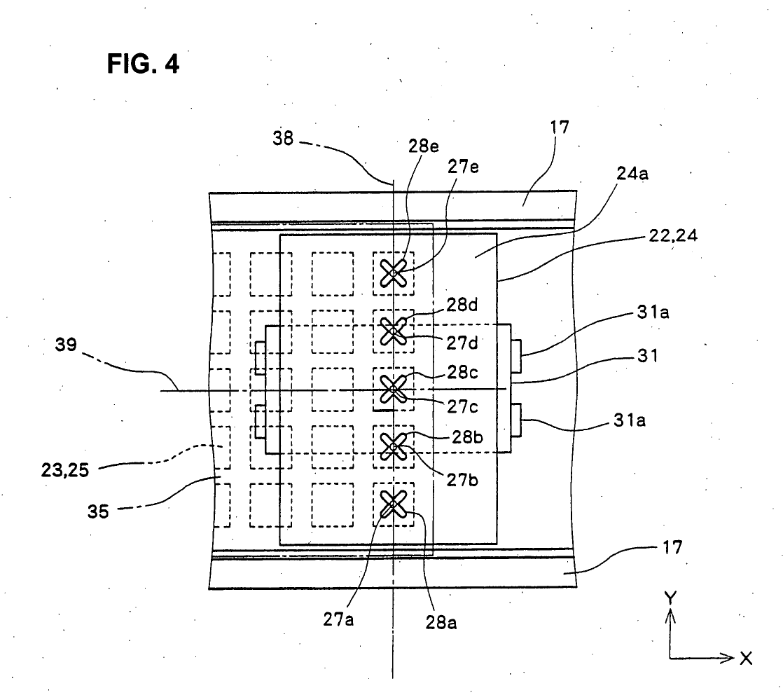

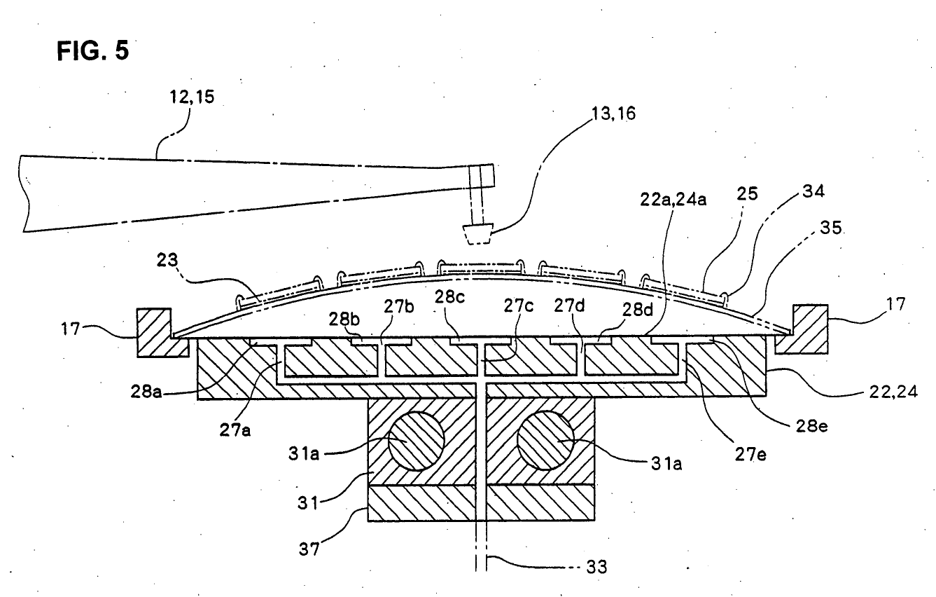

Now, referring to FIG. 4 and FIG. 5, the film application stage 22 and the bonding stage 24 and related portions of the die bonder 10 will be described in detail. As shown in FIG. 4, each of the film application stage 22 and the bonding stage 24 is a block of a flat rectangular plate that is disposed between the frame feeders 17. The film application stage 22 and the bonding stage 24 each have a plurality of the vacuum suction cavities 28a-28e lined up along a Y direction centerline 38 in the middle of each of the substrate suction surface 22a and 24a of the film application stage 22 and the bonding stage 24. Each of the vacuum suction cavities 28a-28e is structured by a pair of grooves with a rectangular vertical cross-section that cross with each other such that the grooves form substantially 45 degrees with the Y direction centerline 38 and the X direction centerline 39, respectively, so that the cross-section of each cavity taken along the horizontal plane is in an X shape. The vacuum suction holes 27a-27e respectively open up at center portions of the X-shaped vacuum suction cavities 28a-28e. Each groove in each of the X-shaped cavities 28a-28e is slightly shorter than a diagonal line of the semiconductor die 25 mounted to the circuit board 35. The shape of the vertical section of the grooves of the vacuum suction cavities 28a-28e is not limited to the rectangular shape, and can be any other shape such as a semicircle. Moreover, the horizontal cross-section is not limited to the X shape as mentioned above, and can be any other shape such as either a cross shape with the grooves forming an angle other than 45 degrees to the Y direction centerline 38 and the X direction centerline 39, respectively, or a star shape having more than two grooves, as long as the grooves extend radially from the center portion of each of the vacuum suction holes 27a-27e so that the circuit board 35 can be efficiently suctioned. In application of the thermocompression film 23 for bonding a semiconductor die, the circuit board 35 is set at a position at which the center of the semiconductor die 25 to be mounted to the circuit board 35 is on the Y direction centerline 38 of the film application stage 22. This position of the circuit board 35 is referred to as a “film application position.” Further, when bonding the semiconductor die 25 to the circuit board 35, the circuit board 35 is set at a position at which the center of the semiconductor die 25 to be mounted to the circuit board 35 is on the Y direction centerline 38 of the bonding stage 24. This position of the circuit board 35 is referred to as a “bonding position.”

FIG. 5 is a cross-sectional view of the film application stage 22 and the bonding stage 24 taken along the Y direction centerline 38 shown in FIG. 4, and each of the vacuum suction cavities 28 is shown in a cross-section in the lengthwise direction of the grooves of the cavities. As shown in FIG. 5, each of the film application stage 22 and the bonding stage 24 is overlaid on and fixed to the heat block 31 that is fixed to a base 37. Each of the vacuum suction holes 27a-27e at the center portion of each of the vacuum suction cavities 28a-28e is connected, within the film application stage 22 or the bonding stage 24, to form a collecting duct, and guided from the film application stage 22 or the bonding stage 24 down through the base 37, then connected to the vacuum pipe 33 under the base 37. Instead of forming the collecting duct in the film application stage 22 and bonding stage 24, each of the vacuum suction holes 27a-27e can be structured so as to penetrate down through the film application stage 22 or the bonding stage 24, so that the vacuum pipe 33 is connected to each of the penetrating portions and bound up into a single collecting duct connected to the vacuum device 26. The vacuum device 26 can be shared by the film application stage 22 and the bonding stage 24, or can be provided for each of the stages 22 and 24.

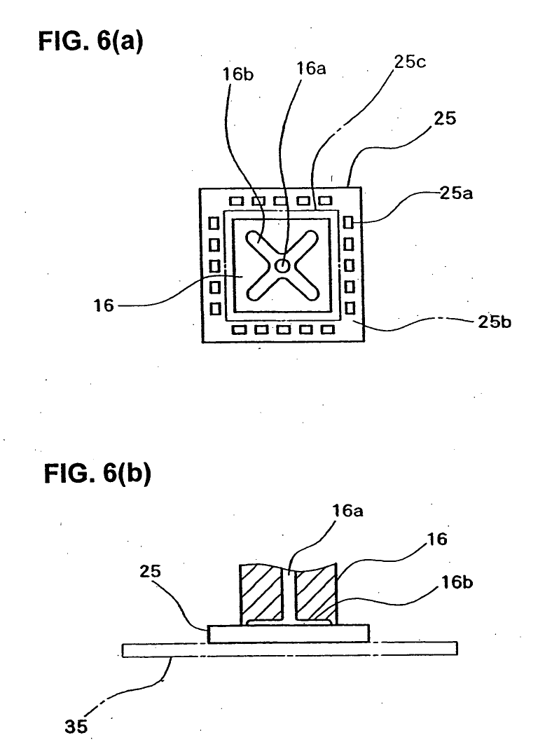

FIGS. 6(a) and 6(b) are diagrams illustrating details of the die collet 16. FIG. 6(a) is a top plan view showing a tip end of the die collet 16, and FIG. 6(b) is a cross-sectional view thereof. As shown in FIGS. 6(a) and 6(b), the die collet 16 has a vacuum suction hole 16a and a vacuum suction cavity 16b for suctioning and holding the semiconductor die 25 at the tip end of the collet 16. The vacuum suction hole 16a is connected to a vacuum device that is not shown in the drawings. The vacuum suction cavity 16b is formed by a pair of grooves with a rectangular vertical cross-section that cross with each other such that the grooves form substantially 45 degrees so that the cross-section of the cavity taken along the horizontal plane is in an X shape, and the vacuum suction hole 16a opens up at a center portion of the X-shaped vacuum suction cavity 16b. The shape of the vertical section of the grooves of the vacuum suction cavity 16b is not limited to the rectangular shape, and can be any other shape such as a semicircle. Moreover, the horizontal cross-section is not limited to the X shape as mentioned above, and can be any other shape such as either a cross shape with the grooves extending along a direction other than the direction of the diagonal line, or a star shape having more than two grooves, as long as the grooves extend radially from the center portion of the vacuum suction hole 16a so that the semiconductor die 25 can be efficiently suctioned. The tip end of the die collet 16 is smaller than a central area 25c of the semiconductor die 25 that is within a periphery area 25b where the electrode pads 25a are disposed and that is provided along a periphery of the semiconductor die 25, so that the die collet 16 will not cause any damage to wires that connect between the semiconductor die 25 that has previously been bonded to the circuit board 35 and the circuit board 35 even when more than one semiconductor die 25 is stack on the circuit board 35. Moreover, the tip end of the die collet 16 can be made of metal, or can be made of hard rubber such as nitro-butyl rubber so that the tip end elastically deforms during the bonding to press the semiconductor die 25 to the circuit board 35.

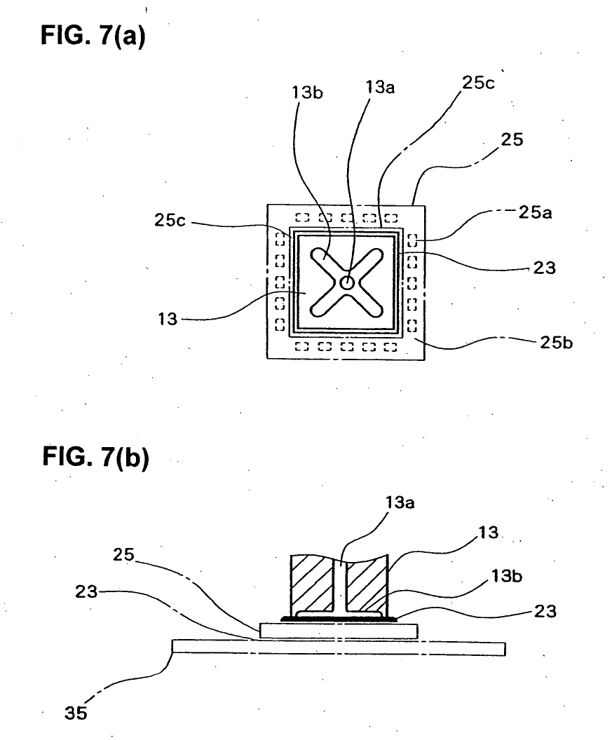

FIG. 7(a) is a top plan view showing a tip end of the film application collet 13, and FIG. 7(b) is a cross-sectional view thereof. As shown in FIGS. 7(a) and 7(b), similarly to the die collet 16, the film application collet 13 has a vacuum suction hole 13a and a vacuum suction cavity 13b at the tip end of the collet 13, and the tip end of the collet 13 is smaller than the central area 25c of the semiconductor die 25.

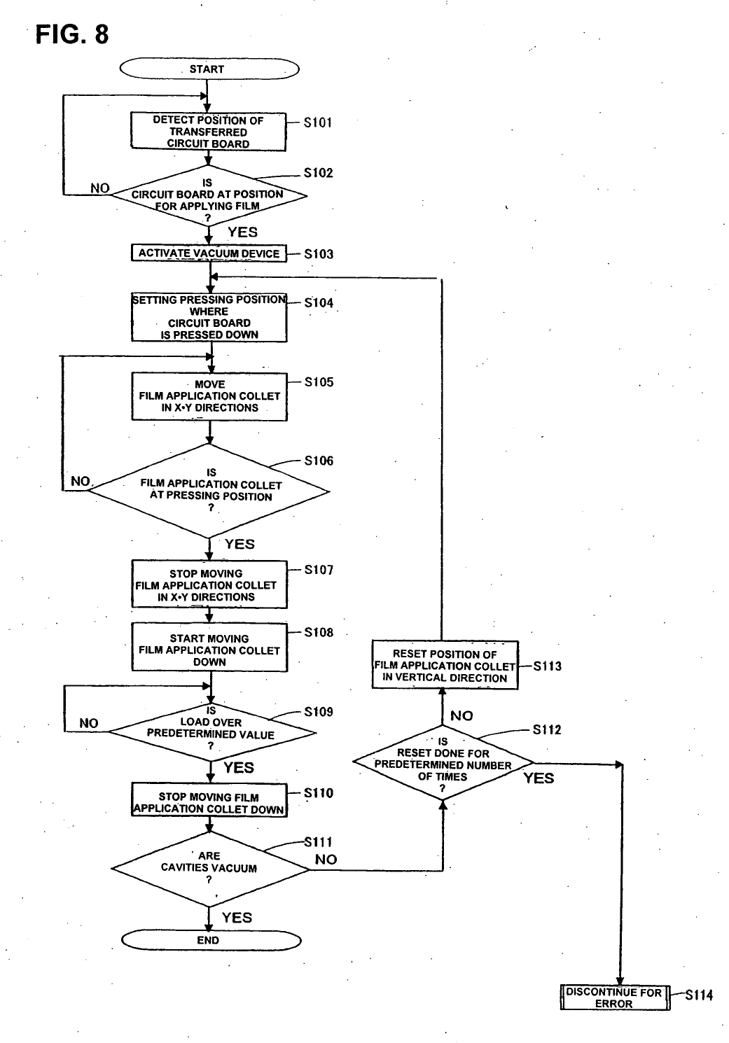

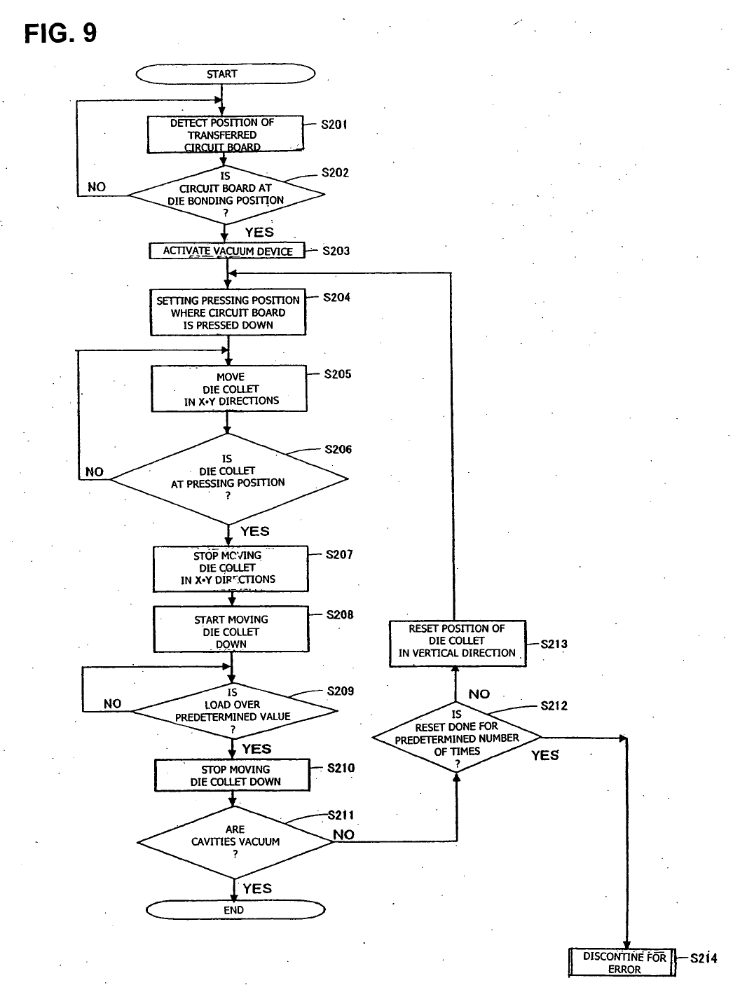

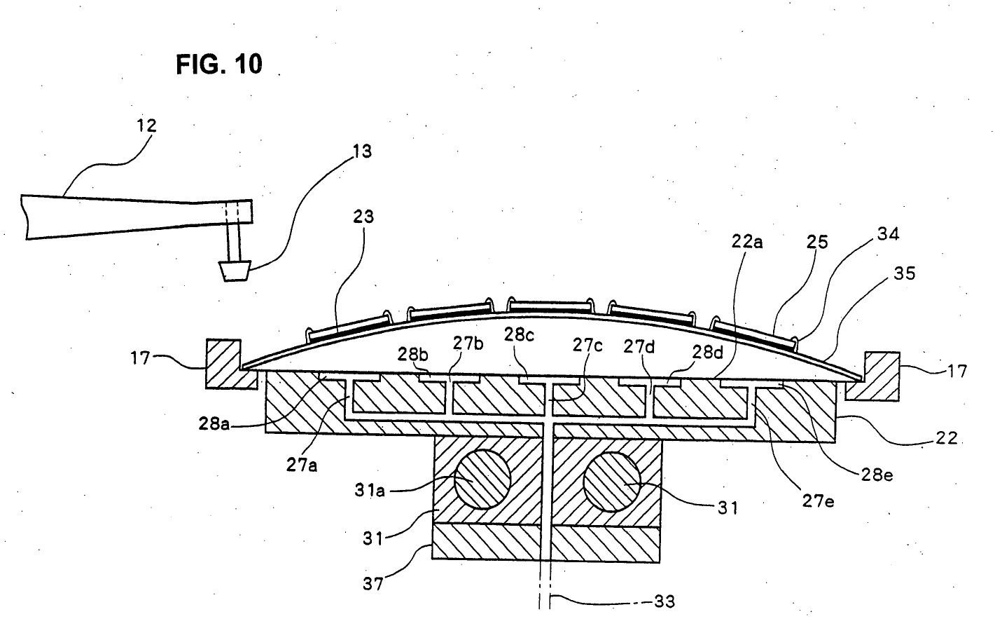

Next, the operation of the method for securing a curved circuit board and the program therefor (recorded on a recording medium) will be described with reference to FIG. 8 through FIG. 18. FIG. 8 and FIG. 9 are flowcharts showing the operation of this exemplary embodiment, and FIG. 10 through FIG. 18 are explanatory diagrams showing the operational states.

When the die bonder 10 is activated, the circuit board 35 fed from the frame loader 20 shown in FIG. 1 is transferred in the X direction to the film application stage 22 by the frame feeders 17. As shown in FIG. 10, the circuit board 35 is provided with the semiconductor die 25 of first stage with the thermocompression film 23 therebetween, and the semiconductor die 25 and the circuit board 35 are connected wires 34. The circuit board 35 curves to a large degree due to the warpage that occurs because the circuit board 35 is thin and the first-stage semiconductor die 25 has already been bonded to the circuit board 35; and as a result, there is a large gap between the curved circuit board 35 and the substrate suction surface 22a of the film application stage 22. The film application arm 12 provided with the film application collet 13 at the tip end stands at a standby position that is not on a transfer path formed by the frame feeder 17 of the circuit board 35, with the film application collet 13 positioning at the ascending position. In this exemplary embodiment, the standby position of the film application arm 12 is described as a position at which the film application collet 13 at the tip end comes outside an area between the frame feeders 17. However, this standby position can be within the area between the both frame feeders 17, as long as the film application collet 13 at the tip end at the standby position does not interfere the curved circuit board 35 that is being transferred. Moreover, when the die bonder 10 is activated, the control unit 81 of the computer 80 outputs to the heat block interface 85 an instruction for starting up the heat block of the film application stage 22, which then activates a heat source 31a to start heating the heat block 31 according to this instruction. The film application stage is heated to, for example, 100-120 degrees Celsius by the heat block 31. The temperature of heating varies depending on bonding properties of the thermocompression film 23 that is applied.

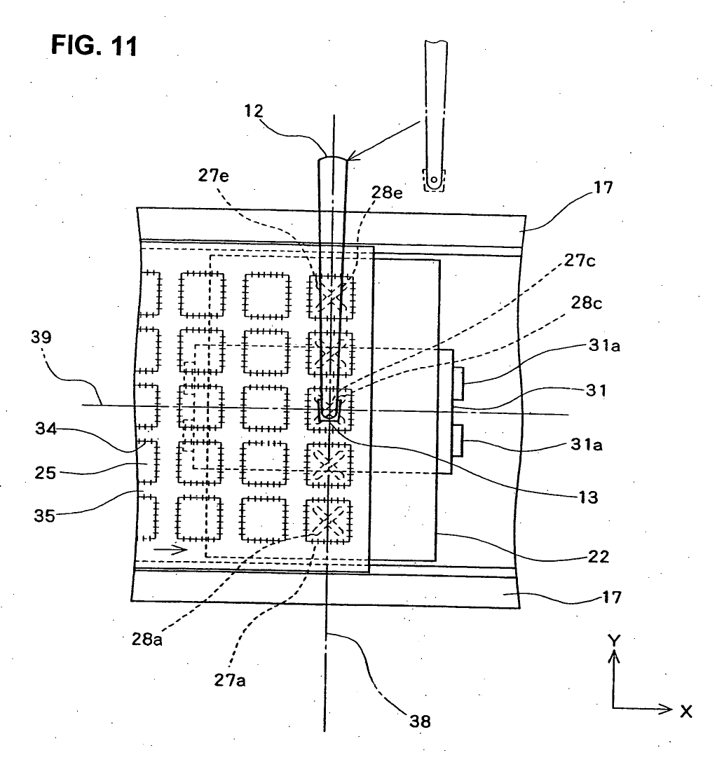

The control unit 81 of the computer 80 starts the operation of the program for suctioning and securing the circuit board 35 to the film application stage 22 shown in FIG. 8. In Step S101 in FIG. 8, when the circuit board 35 is being transferred by the circuit board positioning clamp device 30, whether or not the circuit board 35 has been transferred to a predetermined position by the circuit board positioning clamp device 30 is detected, and a detection signal of the detection is converted by the circuit board positioning clamp device interface 87 into a signal that can be inputted to the control unit 81, and then inputted to the control unit 81. The control unit 81 of the computer 80 detects whether or not the circuit board 35 has reached the film application position as shown in FIG. 11 based on the signal using an image taken by the image pick-up unit 40 via the image pick-up unit interface 88.

When the circuit board 35 reaches the film application position, the circuit board positioning clamp device 30 transmits a film application position reaching signal, which is inputted to the control unit 81 from the circuit board positioning clamp device interface 87. In Step S102 in FIG. 8, the control unit 81 of the computer 80 determines that the circuit board 35 has reached the predetermined film application position based on the input of the signal and outputs an instruction to stop the transfer operation to a transfer apparatus that is not depicted in the drawings. Then, the circuit board 35 is stopped at the film application position.

Next, the control unit 81 of the computer 80 activates the vacuum device 26 in Step S103 in FIG. 8. Because there is a gap between the circuit board 35 transferred to the film application position and the substrate suction surface 22a as shown in FIG. 10, the pressure inside each one of the vacuum suction cavities 28a-28e is not brought to vacuum even after the air in each of the vacuum suction holes 27a-27e is evacuated by the vacuum device 26, and it is not possible to suction and secure the circuit board 35. Consequently, the gap between the circuit board 35 and the substrate suction surface 22a remains the same.

In Step S104 in FIG. 8, the control unit 81 of the computer 80 sets a most suitable pressing position of the circuit board 35 in the X and Y directions based on data of the circuit board 35 that has been previously inputted into the memory unit 83. In this exemplary embodiment, the pressing position is set to a central position of the semiconductor die 25 disposed at the center of the circuit board 35. This is because the central position of the circuit board 35 is appropriate to press the entirety of the circuit board down to the film application stage 22 evenly, and because the pressing down can not cause any damage to the wire 34 that is bonded to the first-stage semiconductor die 25 as no wire 34 is provided at the center of the semiconductor die 25, and further because the suctioning of the circuit board 35 can be more effectively carried out since this position is appropriate to press the circuit board 35 straight down toward the center of the vacuum suction cavity 28c. The pressing position can be a central position of a different one of the semiconductor dies 25 on the circuit board 35 as long as one of the vacuum suction cavities 28a-28e can be sealed. Further, because the tip end of the film application collet 13 is smaller than the central area 25c of the semiconductor die 25 shown in FIG. 6, the pressing position can be any point other than the central position of the semiconductor die 25 and can be set as a position that is the most appropriate based on the structure of the semiconductor die 25 as long as the film application collet 13 does not fall out the central area 25c of the semiconductor die 25.

Once the pressing position of the circuit board 35 is set, as seen from Step S105 in FIG. 8, the control unit 81 of the computer 80 outputs, to the transfer device interface 90, an instruction for moving the position of the film application collet 13 toward the set pressing position in the X and Y directions. As shown in FIG. 3 and FIG. 11, the transfer device interface 90 drives the X-Y table 41 based on this instruction, and starts moving the film application head 11 so that the film application collet 13 at the tip end of the film application arm 12 comes to the pressing position that has been set in the X and Y directions. Then, the control unit 81 of the computer 80 obtains the detection signal from the XY position detecting unit 36 through the XY position detecting unit interface 91 in Step S106 in FIG. 8, and monitors the difference between the position of the tip end of the film application collet 13 and the pressing position that has been set. Further, the difference between the pressing position and an instructed value computed by the computer can be monitored by taking images of the film application collet 13, the semiconductor die 25, and the circuit board 35 using the image pick-up unit 40, by inputting the image data to the control unit 81 through the image pick-up unit interface 88, and by obtaining the tip end position of the film application collet 13 based on image processing using the control unit 81. Then, when the control unit 81 of the computer 80 determines that the difference has crossed over a threshold value, the control unit 81 inputs an instruction to stop the movement of the tip end position of the film application collet 13 to the transfer device interface 90 in Step S107 in FIG. 8. In response to this instruction, the transfer device interface 90 stops the movement of the film application head 11, and consequently stops the movement of the tip end position of the film application collet 13 in the X and Y directions. When the movement of the film application collet 13 stops, the tip end position of the film application collet 13 is at the central position of the semiconductor die 25 at the center of the circuit board 35 as shown in FIG. 11, and the position of the tip end in the Z direction of the film application collet 13 is at a raised position away from the circuit board 35 or the semiconductor die 25.

In Step S108 in FIG. 8, the control unit 81 of the computer 80 outputs, to the transfer device interface 90, an instruction for moving the tip end of the film application collet 13 downward. Based on this instruction, the transfer device interface 90 drives a motor, which is for driving the film application arm 12 and is provided in the film application head 11, to output a signal for moving the tip end of the film application collet 13 downward. Then, the motor of the film application head 11 is driven, and the film application arm 12 starts to rotate downwardly. A signal for detecting the load at the tip end of the film application collet 13 by the load sensor 32 is inputted from the load sensor interface 89 to the control unit 81. The control unit 81 of the computer 80 monitors the difference between the signal and a predetermined grounding load of the film application collet 13 in Step S109 in FIG. 8. The grounding load is a load detected when the tip end of the film application collet 13 grounds (or comes into contact with a bonding object), and it is smaller than a pressure-bonding load of the semiconductor die in the normal die bonding.

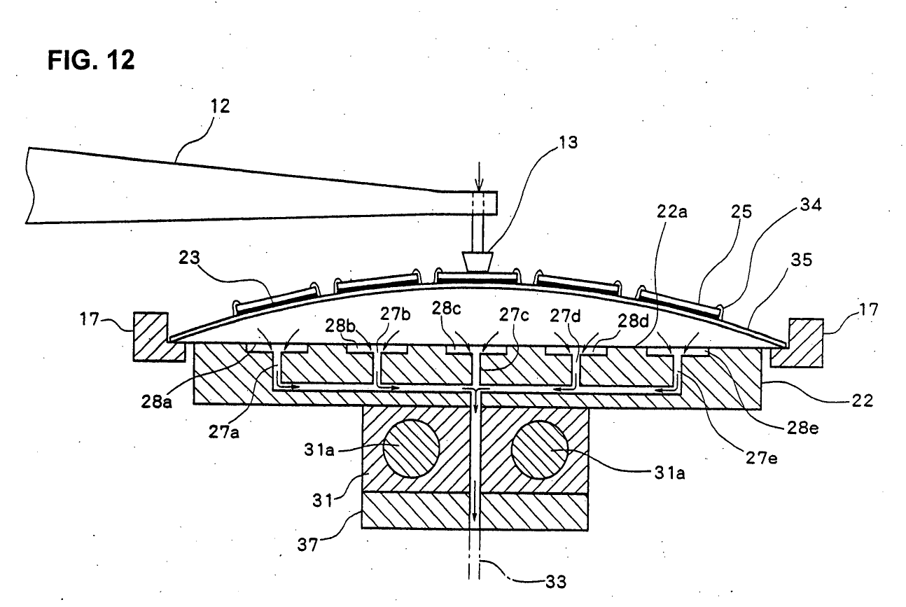

As shown in FIG. 12, the tip end of the film application collet 13 starts to move down to the curved circuit board 35 by the downward movement of the film application arm 12. Then, the tip end of the film application collet 13 is brought into contact with the semiconductor die 25. In this state, there is still a large gap between the circuit board 35 and the substrate suction surface 22a, and air flows through the gap to the vacuum device 26. Accordingly, any of the vacuum suction cavities 28a-28e is not sealed and the circuit board 35 cannot be suctioned by vacuum.

During the downward movement of the film application arm 12, the control unit 81 of the computer 80 continues monitoring whether or not the load at the tip end of the film application collet 13 is equal to or more than the predetermined grounding load based on the signal inputted from the load sensor 32. Then, when the difference between the input signal from the load sensor 32 and the grounding load crosses over the predetermined threshold value, the control unit 81 of the computer 80 determines that the film application collet 13 is grounded (or has come into contact with the circuit board) in Step S109 in FIG. 8, and outputs an instruction for stopping the downward movement of the film application collet 13 to the transfer device interface 90 in Step S110 in FIG. 8. According to this instruction, the transfer device 43 stops the downward movement of the film application arm 12 by stopping the motor of the film application head 11, thus terminating the downward movement of the film application collet 13.

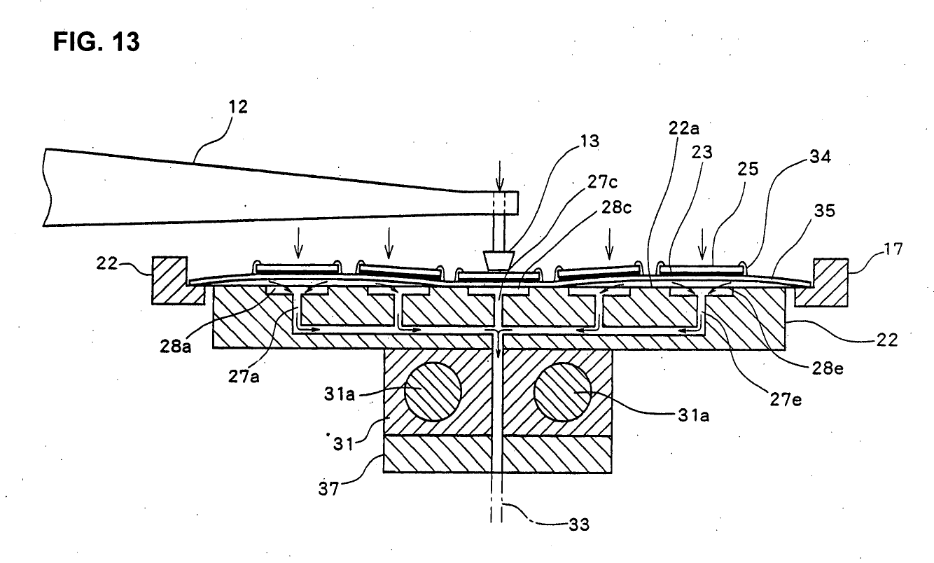

At this time, as shown in FIG. 13, by the downward movement of the tip end of the film application collet 13, the central portion of the circuit board 35 is pressed down to the substrate suction surface 22a of the film application stage 22, the portion of the circuit board 35 below the semiconductor die 25 in the center of the circuit board 35 is brought into contact with the substrate suction surface 22a, and the circuit board 35 covers the upper face of the vacuum suction cavity 28c. In this situation, a portion of an air flow path from the vacuum suction cavities 28a-28e to the vacuum device 26 is blocked, and an amount of air flow to the vacuum device 26 decreases. Consequently, the pressure in all the vacuum suction cavities 28a-28e is reduced. Then, when the pressure in all the vacuum suction cavities 28a-28e becomes lower than the atmosphere pressure, the circuit board 35 starts to be pressed to the film application stage 22 by the atmosphere pressure. This causes the lower face of the circuit board 35 to closely attach in the vicinity of the vacuum suction cavity 28c where the gap between the lower face of the circuit board 35 and the substrate suction surface 22a is the smallest, thereby sealing the upper face of the vacuum suction cavity 28c. By this, the central portion of the circuit board 35 is suctioned to the substrate suction surface 22a. As shown in FIG. 13, the circuit board 35 above the vacuum suction cavities 28a, 28b, 28d, and 28e is not yet closely attached to the substrate suction surface 22a. However, because the vacuum suction cavity 28c is sealed, the amount of air flow evacuated by the vacuum device 26 further decreases, and the pressure in the entire vacuum suction cavities 28a-28e is further reduced. As a result, the circuit board 35 over the vacuum suction cavities 28a, 28b, 28d, and 28e is pressed even more strongly to the film application stage 22 by the atmosphere pressure.

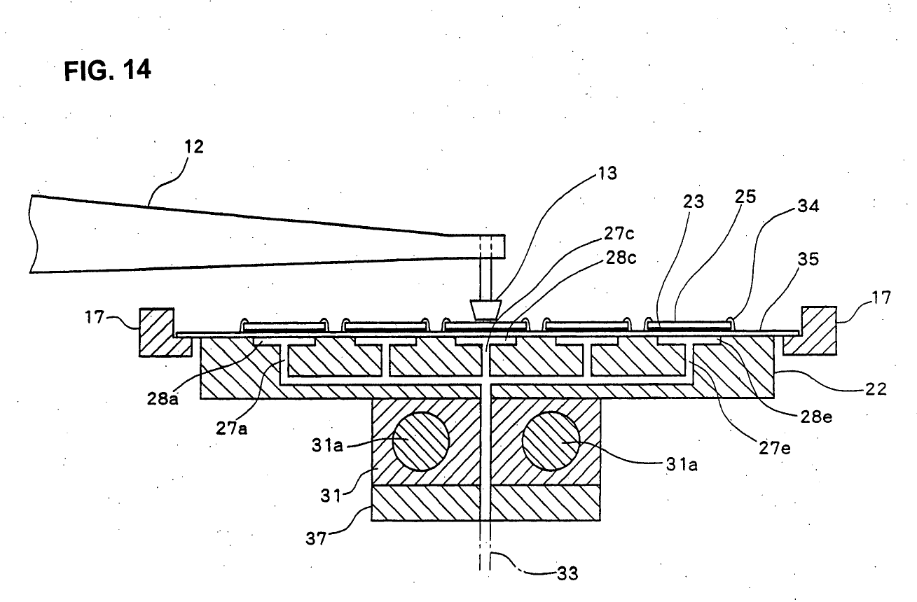

Then, when the circuit board 35 seals the upper face of any one of the vacuum suction cavities 28a, 28b, 28d, and 28e, the air does not flow from the sealed one of the vacuum suction cavities to the vacuum device 26, resulting in further reduction in the pressure in the entire vacuum suction cavities 28a-28e to increase the difference from the atmosphere pressure. As the pressure difference increases, the strength to press the circuit board 35 down also increases, and the vacuum suction cavities 28a-28e are sealed by the circuit board 35 one by one. When all of the vacuum suction cavities 28a-28e are sealed by the circuit board 35, the circuit board 35 is completely suctioned to the film application stage 22 by vacuum. As seen from the above, when one of the vacuum suction cavities is sealed, the pressure in the entire vacuum suction cavities is reduced in a chain reaction, and together with the pressure difference from the atmosphere pressure, the circuit board 35 is rapidly suctioned to the substrate suction surface 22a. When all of the vacuum suction cavities 28a-28e are sealed by the circuit board 35, the circuit board 35 is suctioned and secured to the substrate suction surface 22a as shown in FIG. 14, and the pressures in each of the vacuum suction cavities 28a-28e, in each of the vacuum suction holes 27a-27e, and in the vacuum pipe 33 are brought into substantially vacuum. While the center of the circuit board 35 is pressed down using the film application collet 13 in this exemplary embodiment, it is also appropriate to press down the vacuum suction cavities 28a, 28b, 28c, 28d, and 28e on an end portion of the circuit board 35, in the stated order, instead of pressing down the central portion of the circuit board 35.

In Step S111 in FIG. 8, the control unit 81 of the computer 80 obtains a pressure measured by the pressure sensor 29 as a pressure signal from the pressure sensor interface 86, and determines whether or not the difference between the pressure and a predetermined vacuum pressure has crossed over a predetermined threshold value. Then, when the difference crosses over the predetermined threshold value, the control unit 81 of the computer 80 determines that all of the vacuum suction cavities 28a-28e have been brought to vacuum and the circuit board 35 is suctioned and secured to the film application stage 22.

After confirming this vacuum suction state of the circuit board 35, the control unit 81 of the computer 80 has the transfer device interface 90 raise the film application collet 13 and terminates the program for securing the curved circuit board.

In contrast, when the pressure difference described above does not cross over the predetermined threshold value, the control unit 81 of the computer 80 determines that any of the vacuum suction cavities remains unsealed and is drawing the air and that the circuit board 35 is not fully suctioned and secured. When the vacuum suction state of the circuit board 35 thus cannot be confirmed, the control unit 81 of the computer 80 repeats the press down movement of the circuit board 35 in Step S111 in FIG. 8.

In Step S112 in FIG. 8, the control unit 81 of the computer 80 first determines whether or not the press down movement has been repeated for a predetermined number of times. The predetermined number of times is, for example, a number of times such as once or twice. If the press down movement has already been repeated for the predetermined number of times, the control unit 81 of the computer 80 determines that an error has occurred in the operation of securing the curved circuit board 35, performs a process of discontinuation due to the error in Step S114 in FIG. 8, and stops the die bonder 10.

When the control unit 81 of the computer 80 has not repeated the press down movement for the predetermined number of times in Step S112 in FIG. 8, for example, not even once, the control unit 81 of the computer 80 outputs an instruction to the transfer device interface 90 for resetting the height of the film application collet 13 to an ascending position in Step S113 in FIG. 8. According to this instruction, the transfer device interface 90 drives the motor for the film application head 11 to raise the film application arm 12, and resets the position of the tip end of the film application collet 13 to the ascending position as an initial state. Then, the control unit 81 of the computer 80 changes the setting of the pressing position of the circuit board in the X and Y directions in Step S104 in FIG. 8. The position can be set to the central position of the semiconductor die 25 adjacent to the previous pressing position. Further, the pressure sensors 29 can be attached to the vacuum suction cavities 28a-28e, respectively, so that the central area of the semiconductor die 25 in the vicinity of a vacuum suction cavity with the highest pressure is pressed down.

Then, after setting the pressing position, in Step S105 in FIG. 8, the control unit 81 of the computer 80 again causes the transfer device 43 to move the tip end position of the film application collet 13 to the pressing position that has been reset, and repeats the press down movement as shown in Step S108 through Step S110 in FIG. 8. After confirming the vacuum state of the vacuum suction cavities 28 in Step S111 in FIG. 8, the control unit 81 of the computer 80 determines that the circuit board 35 has been suctioned to the film application stage 22, and terminates the program for securing the curved circuit board shown in FIG. 8.

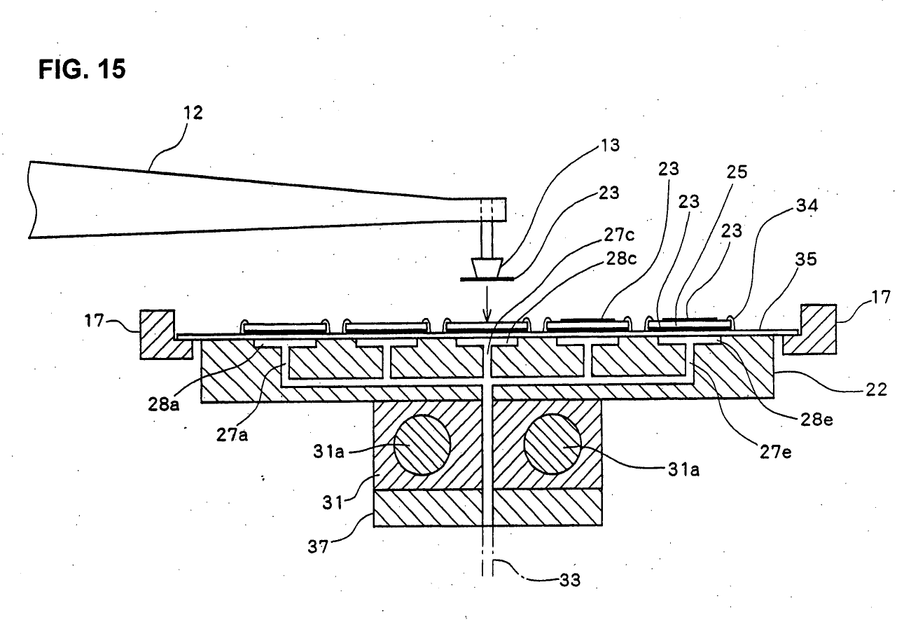

As shown in FIG. 15, when the circuit board 35 is suctioned and secured to the film application stage 22, the circuit board 35 and the semiconductor dies 25 are heated by the heat block 31 that is provided under the film application stage 22 and that has been already heated to up to a temperature at which the heating is possible, so that the thermocompression film 23 can be applied. The control unit 81 of the computer 80 activates a program for applying a thermocompression film, and picks up the thermocompression film 23 using the film application collet 13 to apply the film to the semiconductor die 25. When the application of the thermocompression film 23 is completed for all of the portions to which the films are to be applied on the circuit board 35, the vacuum of the film application stage 22 is released. Once the vacuum is released, the circuit board 35 returns to the upwardly curved state. The control unit 81 of the computer 80 moves the curved circuit board 35 to the bonding stage 24 using the frame feeder 17.

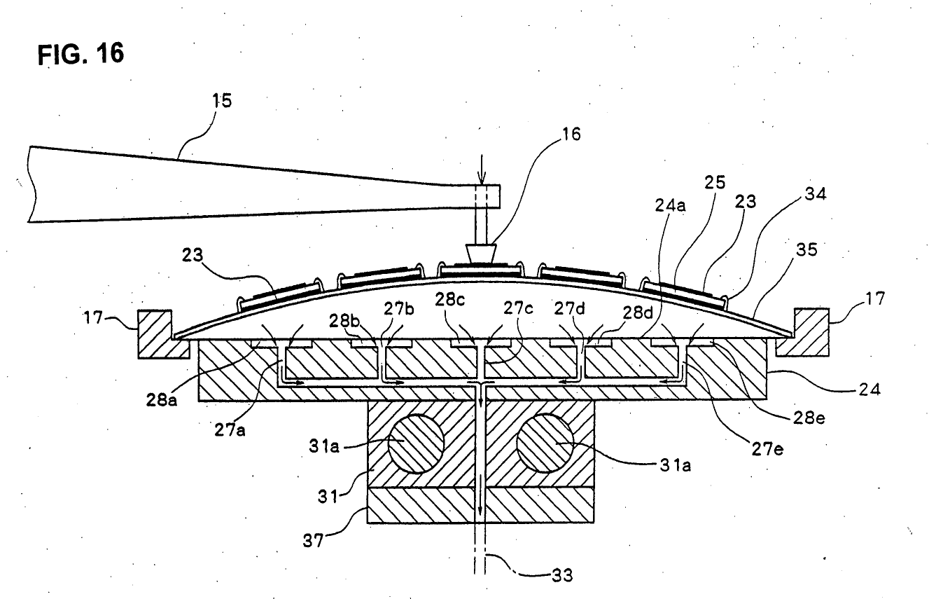

The control unit 81 of the computer 80, while starting to move the curved circuit board 35 to the bonding stage 24, starts an operation of a program for suctioning and securing the circuit board 35 to the bonding stage 24 as shown in FIG. 9. In FIG. 9, characteristics that are the same as the program for securing the film application stage 22 to the circuit board 35 as described with reference to FIG. 8 will not be explained. As shown in FIG. 16, the circuit board 35 has the thermocompression film 23 for bonding a second-stage semiconductor die 25 mounted on the first-stage semiconductor die 25. Accordingly, the warpage of the circuit board 35 is somewhat larger than the warpage of the circuit board 35 when it has been transferred to the film application stage 22, and there is a larger gap between the circuit board 35 and the substrate suction surface 24a of the bonding stage 24. As in the case of the film application as previously described, the bonding arm 15 provided with the die collet 16 at the tip end of the arm stands by at a standby position that is not on the transfer path formed by the frame feeder 17 of the circuit board 35, with the die collet 16 at the tip end positioning at an ascending position. Further, the bonding stage 24 is heated up to, for example, 250-300 degrees Celsius by the heat block 31. The temperature of heating varies depending on the bonding properties of the thermocompression film 23 that is applied. Due to the gap between the curved circuit board 35 and the bonding stage 24, the curved circuit board 35 is little heated.

In Step S201 in FIG. 9, when the circuit board 35 is being transferred by the circuit board positioning clamp device 30, whether or not the circuit board 35 has been transferred to a predetermined position by the circuit board positioning clamp device 30 is detected, and a detection signal of the detection is converted by the circuit board positioning clamp device interface 87 into a signal that can be inputted to the control unit 81, and then inputted to the control unit 81. The control unit 81 of the computer 80 detects whether or not the circuit board 35 has reached the bonding position as shown in FIG. 11 based on the signal using an image taken by the image pick-up unit 40 via the image pick-up unit interface 88.

When the circuit board 35 reaches the bonding position, the circuit board positioning clamp device 30 transmits a bonding position reaching signal, which is inputted to the control unit 81 from the circuit board positioning clamp device interface 87. In Step S202 in FIG. 9, the control unit 81 of the computer 80 determines that the circuit board 35 has reached the predetermined bonding position based on the input of the signal and outputs an instruction to stop the transfer operation to a transfer apparatus that is not depicted in the drawings. Then, the circuit board 35 is stopped at the bonding position.

Next, the control unit 81 of the computer 80 activates the vacuum device 26 in Step S203 in FIG. 9. Then, in Step S204 in FIG. 9, the control unit 81 of the computer 80 sets a most suitable pressing position of the circuit board 35 in the X and Y directions based on data of the circuit board 35 that has been previously inputted into the memory unit 83. In this exemplary embodiment, the pressing position is set to a central position of the thermocompression film 23 that has been applied to the semiconductor die 25 disposed at the center of the circuit board 35, so that the circuit board 35 can be more effectively suctioned and secured. The pressing position can be at the thermocompression film 23 of the central area of a different one of the semiconductor dies 25 on the circuit board 35 as long as one of the vacuum suction cavities 28a-28e can be sealed. Further, because the tip end of the die collet 16 is smaller than the central area 25c of the semiconductor die 25 shown in FIG. 6, the pressing position can be any point other than the central position of the semiconductor die 25 and can be set as a position that is the most appropriate based on the structure of the semiconductor die 25 as long as the die collet 16 does not fall out the central area 25c of the semiconductor die 25.

Once the pressing position of the circuit board 35 is set, as seen from Step S205 in FIG. 9, the control unit 81 of the computer 80 outputs, to the transfer device interface 90, an instruction for moving the position of the die collet 16 toward the set pressing position in the X and Y directions to drive the X-Y table 42 and moves the position of the die collet 16 at the tip end of the bonding arm 15. Then, the control unit 81 of the computer 80, in Step S206 in FIG. 9, monitors the difference between the position of the tip end of the die collet 16 and the pressing position that has been set. Then, when the control unit 81 of the computer 80 determines that the difference has crossed over a threshold value, the control unit 81 stops the movement of the tip end position of the die collet 16 in the X and Y directions in Step S207 in FIG. 9. When this movement of the die collet 16 stops, the tip end position of the die collet 16 is at the central position of the semiconductor die 25 at the center of the circuit board 35, and the position of the tip end in the Z direction of the die collet 16 is at a raised position away from the circuit board 35 or the semiconductor die 25.

In Step S208 in FIG. 9, the control unit 81 of the computer 80 starts moving the tip end of the die collet 16 downward. Then, the signal for detecting the load at the tip end of the die collet 16 by the load sensor 32 is inputted from the load sensor interface 89 to the control unit 81. The control unit 81 of the computer 80 monitors the difference between the signal and a predetermined grounding load of the die collet 16 in Step S209 in FIG. 9. The grounding load is a load detected when the tip end of the die collet 16 grounds (or comes into contact with a bonding object), and it is smaller than a pressure-bonding load of the semiconductor die in the normal die bonding. In addition, this grounding load can be smaller than the load occurring when applying the thermocompression film 23, because making this load smaller than the load for applying the thermocompression film 23 can prevent the thermocompression film 23 from sticking to the die collet 16 when pressing the circuit board 35 downward.

As shown in FIG. 16, the tip end of the die collet 16 starts to move down to the curved circuit board 35 by the downward movement of the bonding arm 15. During this downward movement of the bonding arm 15, the control unit 81 of the computer 80 continues monitoring whether or not the load at the tip end of the die collet 16 is equal to or more than the predetermined grounding load based on the signal inputted from the load sensor 32. When the die collet 16 starts to press down the thermocompression film 23 on the semiconductor die 25 bonded to the circuit board 35, the temperature is not very high due to the gap between the circuit board 35 and the bonding stage 24. Accordingly, it is possible to press the thermocompression film 23 down with the die collet 16 without the thermocompression film 23 melting and sticking to the die collet 16. Then, when the difference between the input signal from the load sensor 32 and the grounding load crosses over the predetermined threshold value, the control unit 81 of the computer 80 determines that the die collet 16 is grounded (or has come into contact with the circuit board) in Step S209 in FIG. 9, and stops the downward movement of the die collet 16.

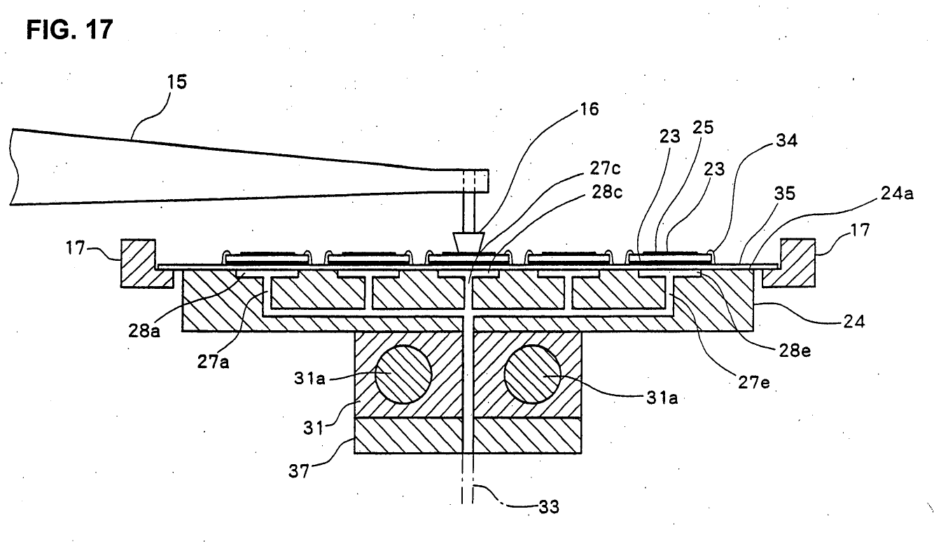

The circuit board 35 is pressed down to the substrate suction surface 24a by the die collet 16, and the lower face of the circuit board 35 closely attaches in the vicinity of the vacuum suction cavity 28c where the gap between the lower face of the circuit board 35 and the substrate suction surface 24a is the smallest, thereby sealing the upper face of the vacuum suction cavity 28c. Subsequently, the surrounding vacuum suction cavities 28a, 28b, 28d, and 28e are sealed by the circuit board 35 one by one. The circuit board 35 is, as a result, suctioned and secured to the substrate suction surface 24a as shown in FIG. 17, and the pressures in each of the vacuum suction cavities 28a-28e, in each of the vacuum suction holes 27a-27e, and in the vacuum pipe 33 are brought into substantially vacuum. While the center of the circuit board 35 is pressed down using the die collet 16 in this exemplary embodiment, it is also appropriate to press down the vacuum suction cavities 28a, 28b, 28c, 28d, and 28e on an end portion of the circuit board 35, in the stated order, instead of pressing down the central portion of the circuit board 35.

In Step S211 in FIG. 9, after confirming this vacuum suction state of the circuit board 35, the control unit 81 of the computer 80 raises the die collet 16 and terminates the program for securing the curved circuit board.

In contrast, when the pressure difference described above does not cross over the predetermined threshold value, the control unit 81 of the computer 80 determines that any of the vacuum suction cavities remains unsealed and is drawing the air and that the circuit board 35 is not fully suctioned and secured. When the vacuum suction state of the circuit board 35 thus cannot be confirmed, the control unit 81 of the computer 80 repeats the press down movement of the circuit board 35 in Step S211 in FIG. 9, as described with reference to FIG. 8.

In Step S212 in FIG. 9, the control unit 81 of the computer 80 determines whether or not the press down movement has been repeated for a predetermined number of times. When the control unit 81 of the computer 80 has not repeated the press down movement for the predetermined number of times, the control unit 81 of the computer 80 resets, in Step S213 in FIG. 9, the position of the tip end of the die collet 16 to an ascending position as an initial state. Then, the control unit 81 of the computer 80 changes the setting of the pressing position of the circuit board in the X and Y directions in Step S204 in FIG. 9. Then, in Step S205 in FIG. 9, the control unit 81 of the computer 80 again causes the transfer device 44 to move the tip end position of the die collet 16 to the pressing position that has been reset, and repeats the press down movement as shown in Step S208 through Step S210 in FIG. 9. After confirming the vacuum state of the vacuum suction cavities 28 in Step S211 in FIG. 9, the control unit 81 of the computer 80 determines that the circuit board 35 has been suctioned to the bonding stage 24, and terminates the program for securing the curved circuit board shown in FIG. 9.

Further, if the press down movement has already been repeated for the predetermined number of times in Step S212 in FIG. 9, the control unit 81 of the computer 80 determines that an error has occurred in the operation of securing the curved circuit board 35, performs a process of discontinuation due to the error in Step S214 in FIG. 9, and stops the die bonder 10.

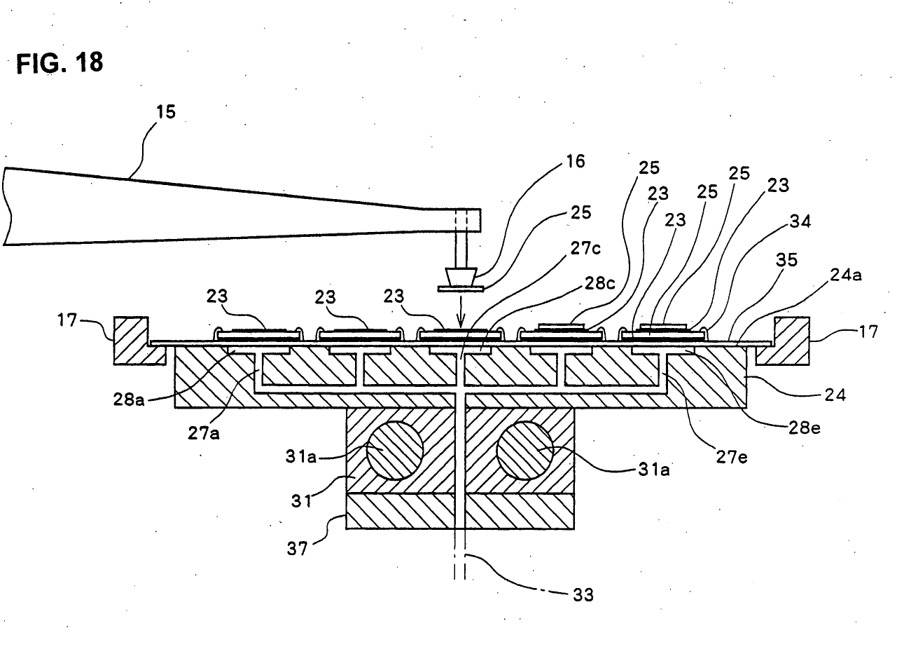

As shown in FIG. 18, when the circuit board 35 is suctioned and secured to the bonding stage 24, the circuit board 35 and the semiconductor die 25 are heated by the heat block 31 that is provided under the bonding stage 24 and that has been already heated to up to a temperature at which the heating is possible, so that the semiconductor die 25 can be bonded. The control unit 81 of the computer 80 activates a bonding program, and pressure-bonds the semiconductor die 25 to the thermocompression film 23 using the die collet 16. When the bonding of the semiconductor die 25 is completed for all of the portions to which the semiconductor die 25 are to be bonded on the circuit board 35, the vacuum of the bonding stage 24 is released and the curved circuit board 35 is then transferred to the frame unloader 21 using the frame feeder 17.

As seen from the above, the above-described exemplary embodiment provides an advantage that the curved circuit board 35 can be easily and effectively suctioned and secured to the film application stage 22 and the bonding stage 24 by vacuum only with a modification to the control programs and without adding any special structure to the die bonder 10 that is commonly employed. Further, because a moving mechanism is not required under the stages, it is possible to carry out the suctioning and heating of the circuit board at the same time, thereby improving the bonding efficiency.

The above-described exemplary embodiment provides another advantage that the curved circuit board 35 is pressed down using the film application collet 13 or the die collet 16 whose tip end is smaller than the central area 25c of the semiconductor die 25. Therefore, the curved circuit board 35 can be suctioned and secured to the film application stage 22 or the bonding stage 24 without damaging the wires 34 bonded between the semiconductor die 25 that has previously been bonded to the circuit board 35 and the circuit board 35 even when more than one semiconductor die 25 is stack on the circuit board 35.

The above-described exemplary embodiment provides a further advantage that a die bonder that bonds the semiconductor die 25 to the circuit board 35 in a single stack or in a multi-stacking manner using a thermocompression film presses down the film application stage 22 and the bonding stage 24 continuously according to the feed of the curved circuit board 35, thereby efficiently secures the circuit board 35. Moreover, the exemplary embodiment provides a further advantage that it is possible to suction and secure the circuit board 35 to the bonding stage 24 without the thermocompression film 23 melting and sticking to the die collet 16, since the surface of the thermocompression film 23 is pressed down by the die collet 16 before the circuit board 35 is heated.

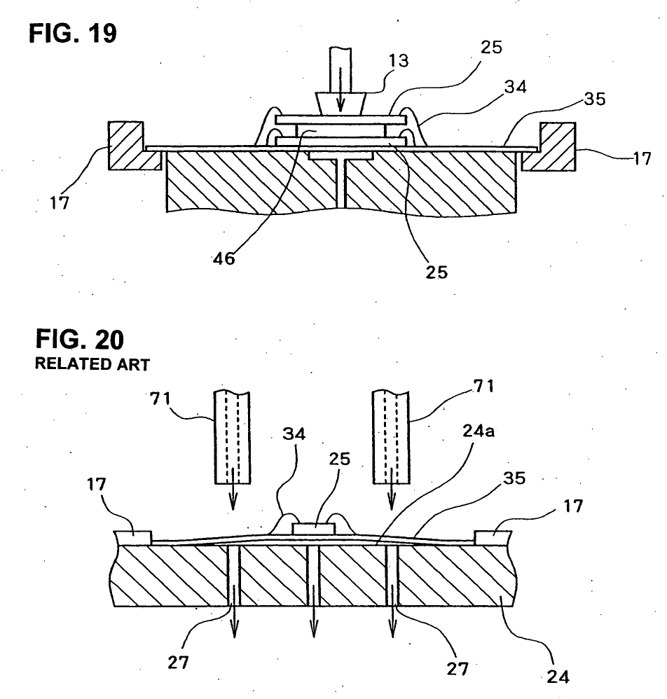

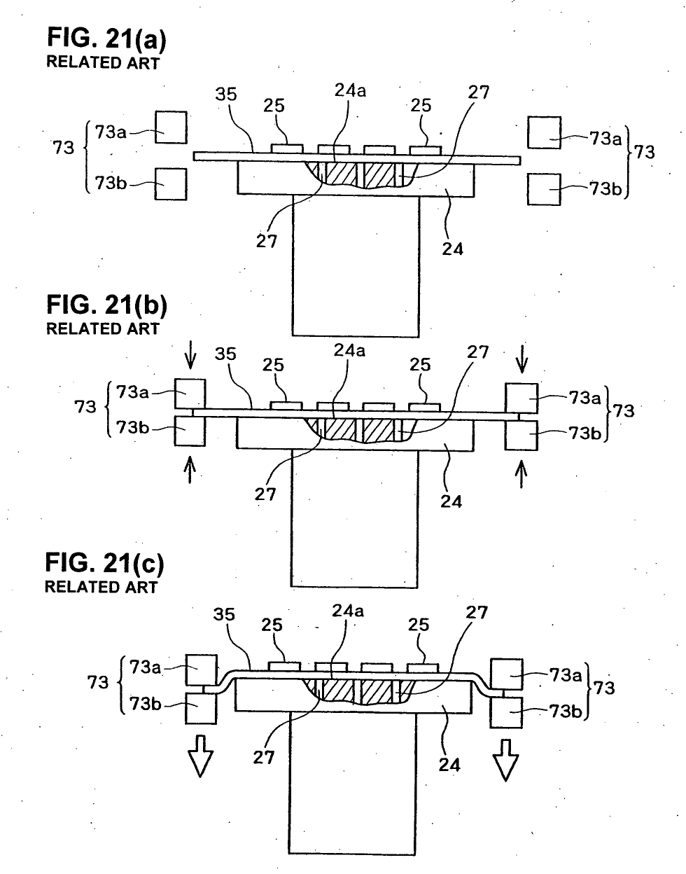

The above exemplary embodiment is described taking the case in which the second semiconductor die 25 that is smaller than the first-stage semiconductor die 25 that has been previously mounted is bonded to the circuit board 35 in a multi-stacking manner. However, as shown in FIG. 19, the exemplary embodiment can be applied to a case in which the semiconductor die 25 of the same size is mounted to the circuit board 35 in a multi-stacking manner with a film spacer 46 therebetween. Further, the above exemplary embodiment is described taking the case in which the curved circuit board 35 on which the first-stage semiconductor die 25 has been mounted to the circuit board 35 with the thermocompression film 23 therebetween is suctioned and secured to the film application stage 22 and the bonding stage 24. However, this exemplary embodiment can be applied to a case in which the curved circuit board 35 on which the semiconductor die 25 is not yet mounted is suctioned and secured to the film application stage 22 and the bonding stage 24.

1. A method for securing a curved circuit board in a die bonder, the method comprising the steps of:
providing a bonding stage having at least one vacuum suction cavity on a substrate suction surface thereof for suctioning a circuit board;
providing a die collet for attaching a semiconductor die to a bonding target; and
pressing down a curved circuit board to the bonding stage using the die collet so that the circuit board seals the at least one vacuum suction cavity.

2. A method for securing a curved circuit board in a die bonder for bonding a semiconductor die to a bonding target with a bonding film interposed therebetween, the method comprising the steps of:
providing a bonding stage having at least one vacuum suction cavity on a substrate suction surface thereof for suctioning a circuit board;
providing a die collet for attaching a semiconductor die to a bonding target;
providing a film application stage having at least one vacuum suction cavity on a substrate suction surface thereof for suctioning a circuit board;
providing a film application collet for applying a bonding film to the bonding target; and
pressing down a curved circuit board to the film application stage using the film application collet so that the circuit board seals the at least one vacuum suction cavity.

3. The method for securing a curved circuit board in a die bonder according to claim 2, wherein
a surface of a tip end of the film application collet is smaller than a central area which is within an electrode pad region provided along a periphery of the semiconductor die, and
when bonding more than one semiconductor die to the circuit board in a multi-stacking manner, the curved circuit board is pressed down to the film application stage using the film application collet by pressing down the central area of the semiconductor die that is disposed either as a single stack semiconductor die or on top of multi-stacked semiconductor dies.

4. The method for securing a curved circuit board in a die bonder according to claim 2, wherein
when bonding more than one semiconductor die to the circuit board in a multi-stacking manner, the curved circuit board is pressed down to the bonding stage using the die collet by pressing down the semiconductor die to which the bonding film is applied and that is disposed either as a single stack semiconductor die or on top of multi-stacked semiconductor dies.

5. The method for securing a curved circuit board in a die bonder according to claim 4, wherein
a surface of a tip end of the die collet is smaller than a central area which is within an electrode pad region provided along a periphery of the semiconductor die, and
the curved circuit board is pressed down to the bonding stage by pressing the central area of the semiconductor die to which the bonding film is applied.

6. The method for securing a curved circuit board in a die bonder according to claim 1, the method comprising the steps, after pressing down the curved circuit board to the bonding stage of:
a vacuum suction state confirming step of confirming whether or not the circuit board has been suctioned by vacuum to the bonding stage application stage; and
a press-down repeating step of, when the vacuum suctioning of the circuit board has not been confirmed in the vacuum suction state confirming step, changing a position in X and Y directions at which the curved circuit board is pressed down, moving one of the die collet and the film application collet that corresponds to the one of the bonding stage and the film application stage to a position after the change, and again pressing the curved circuit board to the one of the bonding stage or the film application stage.

7. A method for securing a curved circuit board in a die bonder for bonding a semiconductor die to a bonding target with a bonding film interposed therebetween, the bonder method comprising the steps of:
providing a bonding stage having at least one vacuum suction cavity on a substrate suction surface thereof for suctioning a circuit board;
providing a die collet for attaching a semiconductor die to a bonding target;
providing a film application stage having at least one vacuum suction cavity on a substrate suction surface thereof for suctioning a circuit board;
providing a film application collet for applying a bonding film to the circuit board; wherein said method comprises:
a circuit board setting step of confirming a position of a curved circuit board that is transferred onto one of the bonding stage and the film application stage and then activating a vacuum apparatus connected to each of the bonding stage and the film application stage;
a pressing position setting step of, after the circuit board setting step, setting a position in X and Y directions at which the curved circuit board is pressed down;
a collet moving step of moving one of the die collet and the film application collet to the position in X and Y directions that has been set in the pressing position setting step, the one of the die collet and the film application collet being corresponding to the one of the bonding stage and the film application stage;
a pressing step of pressing down the curved circuit board to the one of the bonding stage and the film application stage by the one of the die collet and the film application collet so that the circuit board seals the at least one vacuum suction cavity;
a vacuum suction state confirming step of, after the pressing step, confirming whether or not the circuit board has been suctioned by vacuum to the one of the bonding stage and the film application stage; and
a press-down repeating step of, when the vacuum suctioning of the circuit board has not been confirmed in the vacuum suction state confirming step, changing the position in X and Y directions at which the curved circuit board is pressed down, moving the one of the die collet and the film application collet to a position after the change, and again pressing the curved circuit board to the one of the bonding stage and the film application stage.

8. A recording medium recorded with a program for securing a curved circuit board in a die bonder for bonding a semiconductor die to a bonding target with a bonding film interposed therebetween, the die bonder including
a bonding stage having at least one vacuum suction cavity on a substrate suction surface thereof for suctioning a circuit board,
a die collet that attaches a semiconductor die to a bonding target,
a film application stage having at least one vacuum suction cavity on a substrate suction surface thereof for suctioning a circuit board,
a film application collet that applies a bonding film to the bonding target, and
a computer having a control unit, and
the program on said recording medium being executed by the control unit and performing the processes of:
a circuit board setting process for confirming a position of a curved circuit board that is transferred onto one of the bonding stage and the film application stage and then activating a vacuum apparatus connected to each of the bonding stage and the film application stage;
a pressing position setting process, after the circuit board setting process, for setting a position in X and Y directions at which the curved circuit board is pressed down;
a collet moving process for moving one of the die collet and the film application collet to the position in X and Y directions that has been set in the pressing position setting process, the one of the die collet and the film application collet being corresponding to the one of the bonding stage and the film application stage;
a pressing process for pressing down the curved circuit board to the one of the bonding stage and the film application stage by the one of the die collet and the film application collet so that the circuit board seals the at least one vacuum suction cavity;
a vacuum suction state confirming process, after the pressing process, for confirming whether or not the circuit board has been suctioned by vacuum to the one of the bonding stage and the film application stage; and
a press-down repeating process for, when the vacuum suctioning of the circuit board has not been confirmed in the vacuum suction state confirming process, changing the position in X and Y directions at which the curved circuit board is pressed down, moving the one of the die collet and the film application collet to a position after the change, and again pressing the curved circuit board to the one of the bonding stage and the film application stage.

9. The method for securing a curved circuit board in a die bonder according to any one of claims 2 to 5, the method comprising the steps, after pressing down the curved circuit board to one of the bonding stage and the film application stage, of:
a vacuum suction state confirming step of confirming whether or not the circuit board has been suctioned by vacuum to the one of the bonding stage and the film application stage; and
a press-down repeating step of, when the vacuum suctioning of the circuit board has not been confirmed in the vacuum suction state confirming step, changing a position in X and Y directions at which the curved circuit board is pressed down, moving one of the die collet and the film application collet that corresponds to the one of the bonding stage and the film application stage to a position after the change, and again pressing the curved circuit board to the one of the bonding stage or the film application stage.
